(19) United States
(12) Patent Application Publication
(10) Pub. No.: US 2011/0136526 A1
(43) Pub. Date: Jun. 9, 2011

(54) APPARATUS AND METHOD FOR ALLOCATING MULTICAST CONNECTION INDETIFIER IN WIRELESS ACCESS SYSTEM

(75) Inventors: Dae-Geun PARK, Daejeon (KR); Sun-Sim CHUN, Daejeon (KR); Yong-Su LEE, Daejeon (KR); Young-Soo PARK, Daejeon (KR); Young-Il KIM, Daejeon (KR); Sung-Hee KIM, Daejeon (KR); Cheol-Hye CHO, Daejeon (KR)

(73) Assignee: Electronics and Telecommunications Research Institute, Daejeon (KR)

(21) Appl. No.: 12/883,733

(22) Filed: Sep. 16, 2010

(30) Foreign Application Priority Data
Dec. 8, 2009 (KR) 10-2009-0121261
Mar. 23, 2010 (KR) 10-2010-0026000

(51) Int. Cl. H04B 7/00

(52) U.S. Cl. 455/509

(57) ABSTRACT

A base station for allocating an MCID includes: a first transmitting/receiving unit to exchange data with a content distribution network and to extract header information; a combining unit to construct the data on a frame basis; a second transmitting/receiving unit to exchange the frame with a subscriber terminal receiving the constructed frame and to receive a Multicast and Broadcast Service (MBS) channel connection request message; a first analyzing unit to extract attribute information of the data by analyzing the extracted header information and to analyze the type of the data; a second analyzing unit to extract channel information by analyzing the MBS channel connection request message; and a control unit to exchange an MBS burst reservation message with the content distribution network, to reserve/allocate an MBS burst region, to allocate an MCID to the data, and to manage the registration state of an MBS channel corresponding to the MCID.

### CROSS-REFERENCE(S) TO RELATED APPLICATIONS

The present application claims priority of Korean Patent Application Nos. 10-2009-0121261 and 10-2010-0026000, filed on Dec. 8, 2009, and Mar. 23, 2010, respectively, which are incorporated herein by reference in their entirety.

### BACKGROUND OF THE INVENTION

1. Field of the Invention

Exemplary embodiments of the present invention relate to an apparatus and method for allocating a multicast connection identifier in a wireless access system; and, more particularly, to an apparatus and method for allocating a multicast connection identifier to a user in a wireless access system by using a Multicast and Broadcast Service (MBS) mode.

2. Description of Related Art

As generally known in the art, communication systems have been primarily developed for voice communication services, but they are also evolving to provide data services and various multimedia services. However, conventional communication systems, which are mainly directed to providing voice communication services, still have a narrow data transmission bandwidth and require a high subscription fee. For these reasons, they cannot satisfy diversified user demands. Furthermore, in line with rapid development in the communication industry and ever-increasing demands on Internet services, it is increasingly important to provide communication systems capable of providing efficient Internet services. These trends have led to the introduction of wireless access systems having a bandwidth large enough to both satisfy the increasing user demands and provide efficient Internet services.

In addition to providing voice communication services, wireless access systems aim at supporting a variety of low-speed and high-speed data services and multimedia application services (e.g., high-quality moving pictures) in combination. Such multimedia data are transmitted through various networks (e.g., terrestrial networks, cable networks, and IP networks) in accordance with the H.262 (e.g., MPEG2-TS) standard.

The MPEG2-TS standard divides multimedia data into video data, audio data and elementary streams (ESs) (i.e., other data), subdivides each ES into packetized elementary streams (PESs) of up to 64 Kbytes, and transmits each PES by using a packet header suitable for the characteristics of a transmission network. If the transmission network is an IP network, the MPEG2-TS standard divides a PES into packets with a fixed length of 188 bytes and adds an RTP/UDP/IP header to it prior to transmission to a subscriber.

IEEE 802.16 is an example of the wireless access system standard. The IEEE 802.16 standard specifies a Multicast and Broadcast Service (hereinafter referred to as MBS) standard for providing multicast and broadcast to a plurality of mobile terminals. The MBS standard divides multicast and broadcast service zones by using different Connection IDentifiers (CIDs) or different Security Associations (SAs).

Herein, an MBS zone (MBS_ZONE) uses a CID or an SA to indicate that a multicast and broadcast service is available, and a base station uses a Downlink Channel Descriptor (DCD) message to broadcast MBS zone information. That is, the MBS zone may be considered as a group of base stations that use the same CID or SA to transmit contents.

The MBS service uses an MBS zone-based macro diversity technique to simultaneously transmit various channels such as high-quality video and high-quality audio. The IEEE 802.16 standard specifies an MBS Zone Identifier (hereinafter referred to as MBS Zone ID) and a Multicast Connection ID (hereinafter referred to as MCID) to provide such an MBS zone-based broadcast service.

The size of an MBS zone ID is 8 bits, and the maximum number of MBS zones is 128. The size of an MCID is 12 bits (0xFEA0-0xFEFE), and the maximum number of MCIDs is 94. An MBS zone is a group including a plurality of base stations, and an MCID is a unique value corresponding to each broadcast channel in the MBS zone. If the MBS zone is different, the MCID is not unique. That is, if the MBS zone is different, different broadcast channels may have the same MCID or the same broadcast channel may have different MCIDs.

However, such an MBS service scheme divides time, space and broadcast channels by MCIDs and MBS zone IDs and has a limitation in available MCID values and MBS zone ID values. Therefore, the MBS service scheme has a broadcast channel switching time delay due to a broadcast channel change by a subscriber and has difficulty in providing service continuation, thus having a limitation in providing a seamless broadcast service and a suitable channel switching time to a subscriber moving over a wide area.

What is therefore required is an apparatus and method for providing a seamless broadcast service and a suitable channel switching time to a subscriber moving over a wide area, in order to support a successful mobile broadcast service.

### SUMMARY OF THE INVENTION

An embodiment of the present invention is directed to an apparatus and method for allocating a multicast connection identifier to a user in a wireless access system by using a Multicast and Broadcast Service (MBS) mode.

Another embodiment of the present invention is directed to an apparatus and method for allocating a multicast connection identifier in a wireless access system, which allocates a multicast connection identifier (MCID) according to the type of data at a Multicast and Broadcast Service (MBS) service request and fixes the allocated MCID at the same value throughout the entire broadcast zone.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a base station for allocating a Multicast Connection IDentifier (MCID) in a wireless access system includes: a first transmitting/receiving unit configured to exchange data with a content distribution network where a broadcast service providing server is located and to extract header information of the data; a combining unit configured to construct the data on a frame basis in accordance with the data transmission standard of a wireless section; a second transmitting/receiving unit configured to exchange the frame with a subscriber terminal receiving the constructed frame and to receive a Multicast and Broadcast Service (MBS) channel connection request message from the wireless section; a first analyzing unit configured to extract attribute information of the data by analyzing the extracted header information and to analyze the type of the data by using the extracted attribute information; a second analyzing unit configured to extract channel information by analyzing the MBS channel connection request message; and a control unit configured to exchange an MBS burst reservation message with the content distribution network, to reserve/allocate an MBS burst region by using the MBS burst reservation message and the channel information, to allocate an MCID to the data, and to manage the registration state of an MBS channel corresponding to the MCID.

In accordance with another embodiment of the present invention, a subscriber terminal for allocating a Multicast Connection IDentifier (MCID) in a wireless access system includes: an application program executing unit configured to request or terminate a service according to the control of a subscriber and to provide the service execution result to the subscriber; a request analyzing unit configured to classify the requested service as a Multicast and Broadcast Service (MBS) service or a unicast service, to determine whether the service request is the first request, and to generate/transmit a buffer allocation policy according to the determination result; a buffer control unit configured to allocate or release a buffer in accordance with the buffer allocation policy and to manage the allocated buffer space; a frame transmitting unit configured to construct a frame for information transmission and to transmit the constructed frame to a wireless section according to the transmission characteristics of a physical layer; a frame receiving unit configured to receive a packet, transmitted through a wireless access network, through a physical layer and to decode a received signal; a frame analyzing unit configured to classify information included in the received frame on a packet basis by using a wireless section connection identifier included in the decoded frame and to transmit the classified information to a predetermined buffer space; and a frame buffer configured to store data classified on a packet basis according to the type of data.

In accordance with another embodiment of the present invention, a method for allocating a Multicast Connection IDentifier (MCID) in a wireless access system includes: selecting a Multicast and Broadcast Service (MBS) channel and performing a buffer allocation policy; allocating a buffer space of a predetermined size to each data type in accordance with the buffer allocation policy; allocating an MCID value to the data according to a connection request for the MBS channel; receiving a frame with an MBS burst region corresponding to the MCID and classifying/extracting data of the MBS burst region corresponding to the MCID; storing the extracted data in a buffer region corresponding to the MCID of the extracted data; and providing a service by identifying the MBS channel by using multicast IP address information included in an IP header of the data stored in the buffer region.

### BRIEF DESCRIPTION OF THE DRAWINGS

FIG. 1 is a conceptual diagram illustrating network configurations and elements for providing a Multicast and Broadcast Service (MBS).

FIG. 2 is a block diagram of a base station in a wireless access system in accordance with an embodiment of the present invention.

FIG. 3 is a block diagram of a subscriber terminal in a wireless access system in accordance with an embodiment of the present invention.

FIGS. 4A and 4B are flow charts illustrating a process for allocating a Multicast Connection IDentifier (MCID) in a wireless access system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

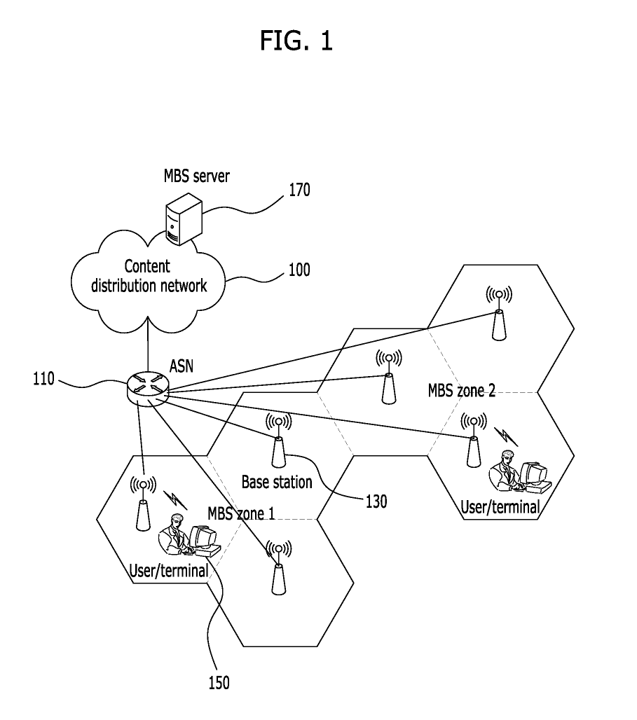

In the following description, detailed descriptions of well-known functions or configurations will be omitted in order not to unnecessarily obscure the subject matters of the present invention. Hereinafter, exemplary embodiments of the present invention will be described in detail with reference to the accompanying drawings. First, network configurations and elements for providing a Multicast and Broadcast Service (MBS) will be described in detail with reference to FIG. 1.

FIG. 1 is a conceptual diagram illustrating network configurations and elements for providing a Multicast and Broadcast Service (MBS).

Referring to FIG. 1, a wireless access system in accordance with an embodiment of the present invention includes a content distribution network 100, an ASN 110, a base station 130, and a subscriber terminal 150. The content distribution network 100 includes an MBS server 170. The present invention will be described on the assumption that MPEG2-TS data are IP-packetized and transmitted through a predetermined path between the MBS server 170 and the subscriber terminal 150, and the wireless access process between the subscriber terminal 150 and the base station 130 conforms to the 802.16-based broadband wireless access system standard.

When a user selects an MBS channel by the subscriber terminal 150, the subscriber terminal 150 transmits an MBS channel connection request message to the base station 130. Herein, the subscriber terminal 150 connects to a wireless access network to transmit/receive various data and process the transmitted/received data. The base station 130 manages a data channel and a wireless resource control for supporting a macro diversity function.

Then, the base station 130 transmits the MBS channel connection request message to the MBS server 170. The MBS server 170 includes channel or program information that is a combination of MCID, MBS zone ID, IP multicast address, program ID, and content ID, and performs IP multicast group management, program management, service guide announcement/distribution, session management, and data encryption key management.

The MBS server 170 uses the MBS channel connection request message of the subscriber terminal 150 to perform subscriber authentication and service authentication. If the authentication is successful, the MBS server 170 transmits a response message, which includes various information such as a decryption key, a program ID, and a user ID for use of the requested MBS channel, to the subscriber terminal 150. Also, the MBS server 170 notifies the initiation of an MBS channel service to the ASN 110.

The ASN 110 performs various operations such as channel establishment, session management, synchronization control, and data path establishment/release under the control of the MBS server 170. That is, when receiving an MBS channel service initiation notification message from the MBS server 170, the ASN 110 transmits an MBS burst region reservation request message to the base station 130.

Then, the base station 130 receives a reservation message from the MBS server 170 and transmits a response message to the ASN 110 in response to the reservation message. Also, the MBS server 170 and the ASN 110 perform channel establishment for MBS channel data transmission between the MBS server 170 and the ASN 110 according to a predetermined process.

Upon completion of the path establishment for the MBS channel data transmission, the MBS server 170 converts MPEG2-TS data, requested by the user through the subscriber terminal 150, into an IP packet and transmits the same through the established path to the base station 130.

The base station 130 constructs an MBS burst region including an MCID corresponding to the attribute of an input packet by using MCID/MBS burst region information and packet attribute information obtained by analyzing the IP packet. Also, the base station 130 constructs a complete frame by combining the MBS burst region and unicast-type service data regions, and transmits the constructed frame to the subscriber terminal 150.

The subscriber terminal 150 may provide a service of an MBS channel by identifying the MBS channel requested by the user through the multicast IP address information included in the IP header of a packet. Herein, the respective channels may be identified by using different multicast IP addresses. The subscriber terminal 150 receives broadcast channel information from the MBS server 170 periodically or non-periodically, and performs a broadcast channel service connection request/release through an IGMP join/leave message.

The broadcast channel information includes program ID, multicast IP address, and MBS zone ID. The service connection request/release is performed through the point-to-point connection between the subscriber terminal 150 and the base station 130. Broadcast contents are divided into an MBS-type service, which is a broadcast service provided in real time, and a unicast-type service, which is provided in the shape of VoD, and such broadcast service type information is included in the broadcast channel information.

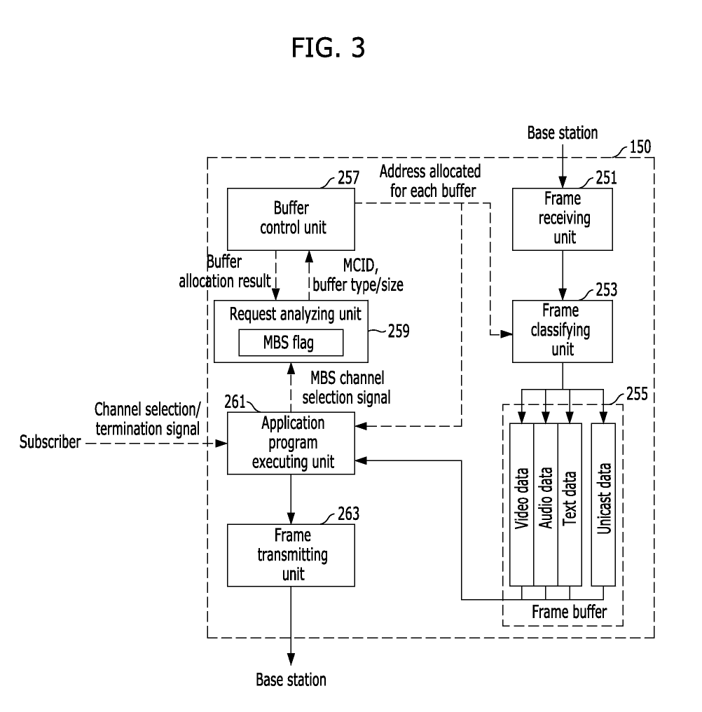

The MBS-type broadcast contents have a point-to-multipoint connection between the base station 130 and the subscriber terminal 150, and the unicast-type broadcast contents have a point-to-point connection between the base station 130 and the subscriber terminal 150. Hereinafter, the elements of the subscriber terminal 150 in the wireless access system in accordance with an embodiment of the present invention will be described in detail with reference to FIG. 3.

FIG. 3 is a block diagram of the subscriber terminal 150 in the wireless access system in accordance with an embodiment of the present invention.

Referring to FIG. 3, the subscriber terminal 150 in the wireless access system in accordance with an embodiment of the present invention includes a buffer control unit 257, a request analyzing unit 259, an application program executing unit 261, a frame transmitting unit 263, a frame receiving unit 251, a frame classifying unit 253, and a frame buffer 255. The user receives channel information of channels, which are viewable through an application program (e.g., an Electronic Program Guide (EPG)) executed by the application program executing unit 261, from the MBS server 170. Herein, the channel information includes program ID, multicast IP address, and MBS zone ID.

The user selects an MBS channel through the application program executed by the application program executing unit 261 of the subscriber terminal 150, and the subscriber terminal 150 generates an MBS channel selection signal or an MBS channel termination signal according to the user's selection. The request analyzing unit 259 receives an MBS channel selection signal from the application program executing unit 261, and checks the setting state of an MBS flag to determine whether the connection of the MBS channel requested by the received MBS channel selection signal is the first connection request.

If it is determined by the MBS flag check result that the user has accessed the MBS zone for the first time, the request analyzing unit 259 performs a buffer allocation policy and the buffer control unit 257 allocates a buffer for each MCID according to the buffer allocation policy. Herein, if it is determined that the user has again accessed the same MBS zone, the above process is omitted.

More specifically, the request analyzing unit 259 checks the state of the MBS flag to determine whether the user is a first-accessed user or an again-accessed user. If it is determined by the check result that the user has accessed the MBS zone for the first time, the request analyzing unit 259 performs a buffer allocation policy. The buffer allocation policy is used to allocate independent buffers for respective attributes such as text data, audio data, and video data constituting MPEG2-TS data in order to provide an MBS-type service. The buffer allocation policy includes information such as an MCID corresponding to each buffer, the size of each buffer, and the type of each buffer.

The buffer control unit 257 receives the buffer allocation policy from the request analyzing unit 259, allocates a buffer space of a predetermined size in the frame buffer 255 for each of video data, audio data and text data according to the received buffer allocation policy, and transmits address information allocated to each buffer type to the frame classifying unit 253 and the application program executing unit 261. Also, the buffer control unit 257 transmits the buffer allocation result to the request analyzing unit 259.

That is, if it is determined that the subscriber terminal 150 is a first-accessed subscriber terminal of the MBS zone and if it is determined by the buffer allocation result received from the buffer control unit 257 that the buffer allocation has been normally performed, the request analyzing unit 259 changes the setting state of the MBS flag into a value indicating that it is not the first request. The application program executing unit 261 generates an MBS channel connection request message for the broadcast channel selected by the user and transmits the MBS channel connection request message to the frame transmitting unit 263.

If the user again accesses the same MBS zone, a buffer allocation policy and a process of allocating a buffer for each MCID according to the buffer allocation policy are not performed. Herein, the application program executing unit 261 generates an MBS channel connection request message for the broadcast channel selected by the user and transmits the MBS channel connection request message to the frame transmitting unit 263.

The frame receiving unit 251 receives an MBS channel connection request response message from the MBS server 170 in response to the MBS channel connection request message and transmits the MBS channel connection request response message to the frame classifying unit 253. Herein, the MBS channel connection request response message includes information necessary for normal use of the channel selected by the user, such as a user ID, a program ID, and a decryption key for decrypting the encrypted contents.

The frame classifying unit 253 stores the MBS channel connection request response message, received from the MBS server 170, in a unicast data buffer. The application program executing unit 261 reads the MBS channel connection request response message stored in the unicast data buffer through a related program.

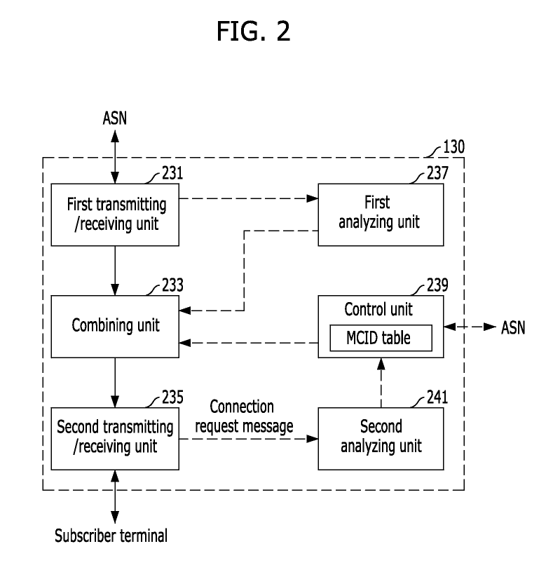

Herein, the related program in the application program executing unit 261 performs pre-processes for processing MBS channel data. If the frame classifying unit 253 receives an MCID allocation notification message from the base station 130 that will be described below with reference to FIG. 2, it extracts MCID values included in the received MCID allocation notification message, records the same, generates a response message for the MCID allocation notification message, and transmits the generated response message to the base station 130 of FIG. 2.

The MCID allocation notification message includes an MCID value corresponding to the attribute of text data, audio data and video data of the MBS channel data. Herein, a process of transmitting the MCID allocation notification message and the MCID allocation notification response message between the subscriber terminal 150 and the base station 130 of FIG. 2 conforms to a Dynamic Service Addition (DSA) process defined in the 802.16-based broadband wireless access system.

The DSA process includes transmitting a DSA request message (DSA-REQ) from the base station 130 to the subscriber terminal 150, transmitting a DSA response message (DSA-RSP) from the subscriber terminal 150 to the base station 130, and transmitting a DSA acknowledgement message (DSA-ACK) for the DSA response message from the base station 130 to the subscriber terminal 150.

When the frame classifying unit 253 receives a frame with an MBS burst region corresponding to a predetermined MCID, the frame classifying unit 253 classifies/extracts data of an MBS burst region corresponding to each predetermined MCID. Also, the frame classifying unit 253 stores the extracted data in a buffer corresponding to each predetermined MCID.

The application program executing unit 261 uses a video player or an audio player to receive data that are classified into video data, audio data and text data and are stored in the respective buffer regions. Thereafter, the application program executing unit 261 may provide a service of an MBS channel by identifying the MBS channel requested by the user through multicast IP address information included in the IP header of a packet. Hereinafter, the elements of the base station 130 in the wireless access system in accordance with an embodiment of the present invention will be described in detail with reference to FIG. 2.

FIG. 2 is a block diagram of the base station 130 in the wireless access system in accordance with an embodiment of the present invention.

Referring to FIG. 2, the base station 130 includes a first transmitting/receiving unit 231, a combining unit 233, a second transmitting/receiving unit 235, a first analyzing unit 237, a control unit 239, and a second analyzing unit 241. The second transmitting/receiving unit 235 receives an MBS channel connection request message from the frame transmitting unit 263 of the subscriber terminal 150, and transmits the received MBS channel connection request message to the second analyzing unit 241.

The second analyzing unit 241 analyzes the MBS channel connection request message, received from the second transmitting/receiving unit 235, to extract attribute information such as an ID or CID of the user sending the MBS channel connection request message, the occurrence/nonoccurrence of an MBS-type service connection request, a program ID, and a multicast IP address of a broadcast channel. The second analyzing unit 241 transmits the extracted attribute information to the control unit 239.

Herein, the occurrence/nonoccurrence of an MBS-type service connection request may be determined by the content and type of the received MBS channel connection request message. If the received MBS channel connection request message is an IGMP join message, it may be determined to be an MBS-type service connection request. Also, if the received MBS channel connection request message is an IGMP leave message, it may be determined to be an MBS-type service connection release request. Besides, an additional dedicated message may be used for the same purpose.

The control unit 239 receives the attribute information from the second analyzing unit 241 and searches an MCID table by using the received attribute information. It is determined according to the search result whether identification information (e.g., a user ID or CID) of the user transmitting the MBS channel connection request message is registered. Herein, the MCID table records identification information of the user using an MCID, and a program ID and a multicast IP address that is information about a broadcast channel that is being serviced through the MCID.

If the identification information of the user transmitting the MBS channel connection request message has not been registered in the MCID table, that is, if the user is a first-accessed user of the MBS zone, the control unit 239 transmits a predetermined MCID value to the subscriber terminal 150 of FIG. 3 according to the video, audio and text attribute of MPEG2-TS data. Also, the control unit 239 transmits the MBS channel connection request message through the first transmitting/receiving unit 231 to the MBS server 170.

If the identification information of the user transmitting the MBS channel connection request message has already been registered in the MCID table, that is, if the user is an again-accessed user of the same MBS zone, the control unit 239 transmits the MBS channel connection request message through the first transmitting/receiving unit 231 to the MBS server 170.

Then, the control unit 239 transmits MCID/MBS burst allocation information to the combining unit 233 and transmits the MBS channel connection request message to the ASN 110. Thereafter, the ASN 110 transmits the MBS channel connection request message to the MBS server 170. The MBS server 170 performs subscriber authentication and service authentication with respect to the MBS channel connection request of the subscriber terminal 150. If the authentication is successful, the ASN 110 transmits a response message for the MBS channel connection request to the subscriber terminal 150 of FIG. 3.

The MBS server 170 transmits an MBS channel service initiation notification message to the ASN 110. When receiving the MBS channel service initiation notification message from the MBS server 170, the ASN 110 transmits an MBS burst region reservation request message to the base station 130.

The control unit 239 of the base station 130 receives the MBS burst region reservation request message from the ASN 110 and reserves a burst region corresponding to each MCID recorded in the MCID table. Thereafter, the control unit 239 transmits a response message for the MBS burst region reservation request to the ASN 110. The base station 130 performs path establishment for MBS channel data transmission between the MBS server 170 and the ASN 110 and between the base station 130 and the ASN 110 according to a predetermined method.

After normal completion of the MBS burst region reservation and the MBS channel data path establishment, it is determined whether the user is a first-accessed user of the MBS zone. If it is determined that the user is a first-accessed user of the MBS zone, the control unit 239 transmits an MCID allocation notification message to the subscriber terminal 150 of FIG. 3. If it is determined that the user is an again-accessed user of the same MBS zone, the control unit 239 omits the above process and updates the attribute information (e.g., user identification information, a program ID, and a multicast IP address), obtained through the path establishment, in the MCID table.

The MCID allocation notification message for each MBS channel data attribute includes an MCID value according to the video, audio and text attribute of the MBS channel data. After completion of the path establishment, the MBS server 170 converts the MPEG2-TS data, requested through the subscriber terminal 150 of FIG. 3, into IP-packetized data and transmits the IP-packetized data through the ASN 110 to the first transmitting/receiving unit 231 of the base station 130. The first transmitting/receiving unit 231 extracts header information of the IP-packetized MPEG2-TS data.

The first transmitting/receiving unit 231 transmits the extracted header information to the first analyzing unit 237. The first analyzing unit 237 analyzes the extracted header information to extract a destination IP address or an source IP address of the received packet. Also, the first analyzing unit 237 uses the destination IP address or the source IP address to divide the data into MBS-type data and unicast-type data.

In particular, if the multicast IP address of the MBS channel is included in the extracted IP address, it is determined that the received packet includes MBS-type service data. Thus, in this case, the first analyzing unit 237 divides the attribute of the received packet into video, audio or text by using a multimedia attribute, and transmits the analyzed information to the combining unit 233.

The combining unit 233 constructs an MBS burst region including an MCID corresponding to the attribute of an input packet by using the packet attribute information received from the first analyzing unit 237 and the MCID/MBS burst allocation information received from the control unit 239. Thereafter, the combining unit 233 combines the MBS burst region and unicast-type service data regions to construct a complete frame. The combining unit 233 transmits the constructed frame to the second transmitting/receiving unit 235.

The second transmitting/receiving unit 235 outputs a signal, which is obtained by modulating frame data including the MBS burst region in accordance with the standard of a physical layer, to a wireless section. The frame receiving unit 251 of the subscriber terminal 150 receives a frame from the second transmitting/receiving unit 235 of the base station 130 and transmits the received frame to the frame classifying unit 253. If the frame has an MBS burst region corresponding to a predetermined MCID, the frame classifying unit 253 classifies the frame into data of the MBS burst region corresponding to the predetermined MCID prior to extraction.

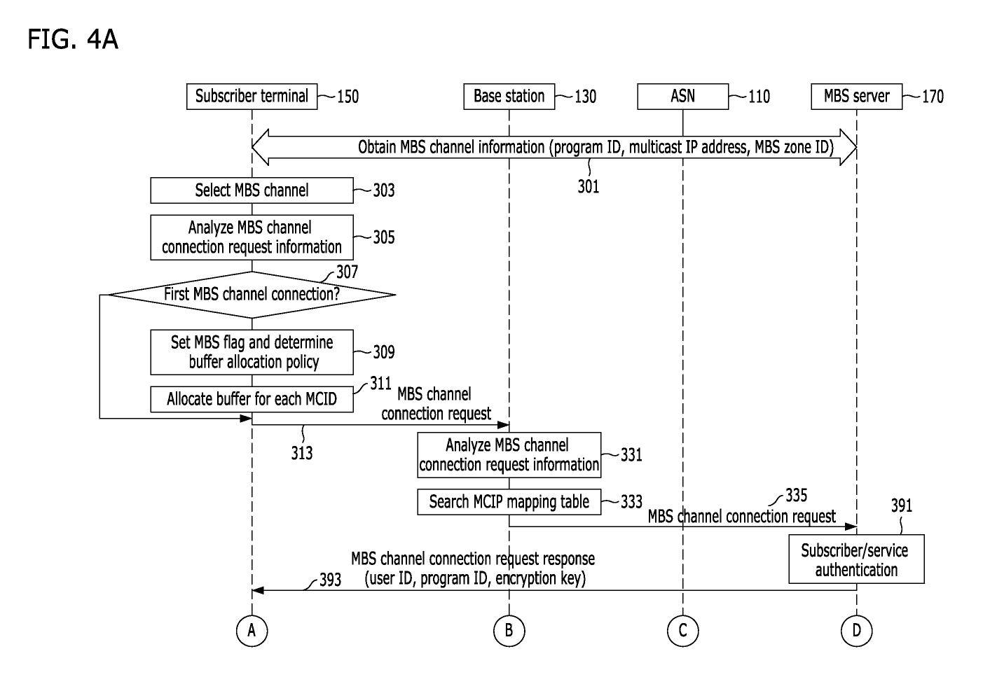

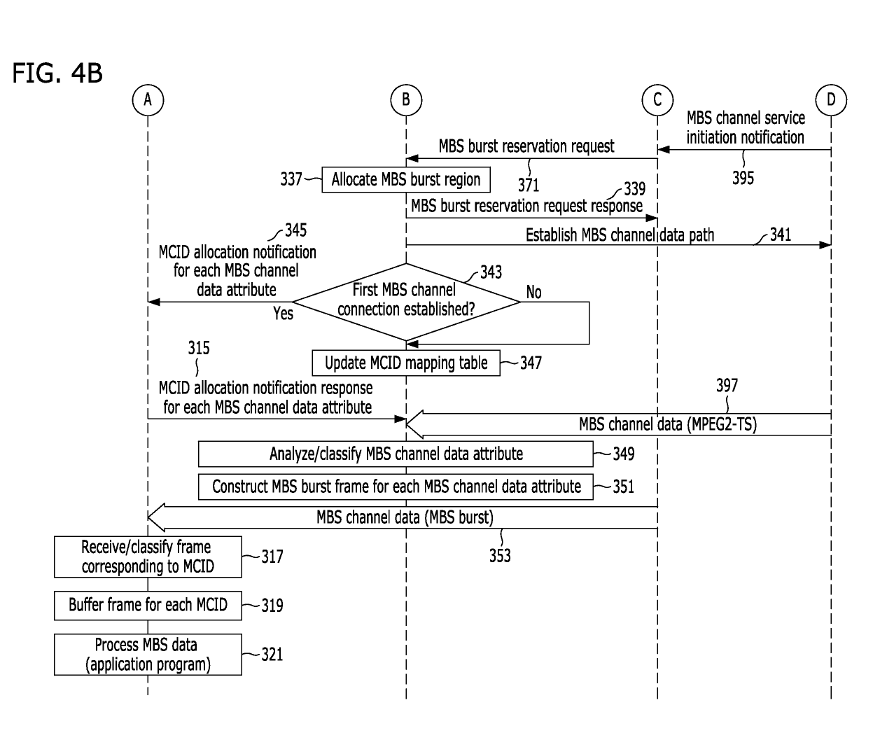

Hereinafter, a process for allocating a Multicast Connection IDentifier (MCID) in the wireless access system in accordance with an embodiment of the present invention will be described in detail with reference to FIGS. 4A and 4B.

FIGS. 4A and 4B are flow charts illustrating a process for allocating a Multicast Connection IDentifier (MCID) in the wireless access system in accordance with an embodiment of the present invention.

Referring to FIGS. 4A and 4B, at step 301, the user receives channel information of channels, which are viewable through an application program (e.g., an Electronic Program Guide (EPG)) executed by the application program executing unit 261, from the MBS server 170. Herein, the channel information includes program ID, multicast IP address, and MBS zone ID.

At step 303, the user selects an MBS channel through the application program and the subscriber terminal 150 generates an MBS channel selection signal or an MBS channel termination signal. At step 307, the request analyzing unit 259 receives an MBS channel selection signal from the application program executing unit 261, and checks the setting state of an MBS flag to determine whether the connection of the MBS channel requested by the received MBS channel selection signal is the first connection request. If the channel selection signal is the first connection request for the MBS channel, the request analyzing unit 259 performs a buffer allocation policy at step 309.

Herein, the buffer allocation policy is used to allocate independent buffers for respective attributes such as text data, audio data, and video data constituting MPEG2-TS data in order to provide an MBS-type service. The buffer allocation policy includes information such as an MCID corresponding to each buffer, the size of each buffer, and the type of each buffer.

At step 311, the control unit 257 receives the buffer allocation policy from the request analyzing unit 259 and allocates a buffer space of a predetermined size in the frame buffer 255 for each of video data, audio data and text data according to the received buffer allocation policy. Also, the control unit 257 transmits address information allocated to each buffer type to the frame classifying unit 253 and the application program executing unit 261. Also, the buffer control unit 257 transmits the buffer allocation result to the request analyzing unit 259.

That is, if it is determined that the connection of the MBS channel requested by the MBS channel selection signal received from the application program executing unit 261 is the first connection request and if it is determined by the buffer allocation result received from the buffer control unit 257 that the buffer allocation has been normally performed, the request analyzing unit 259 changes the setting state of the MBS flag into a value indicating that it is not the first request. If the same user requests a service connection for the MBS channel, the step 309 and the step 311 are not preformed.

At step 313, the application program executing unit 261 generates an MBS channel connection request message for the broadcast channel selected by the user and transmits the generated MBS channel connection request message to the frame transmitting unit 263. Herein, the frame transmitting unit 263 constructs data to be transmitted to the base station 130 (e.g., the MBS channel connection request message generated by the application program executing unit 261) into a frame according to the predetermined structure and the characteristics of a physical layer. Also, the frame transmitting unit 263 transmits the constructed frame to the base station 130 according to the wireless resource access control of the base station 130.

Herein, the MBS channel connection request message may be transmitted to the base station 130 between the step 301 and the step 305. At step 331, the second transmitting/receiving unit 235 of the base station 130 receives the MBS channel connection request message form the frame transmitting unit 263 of the subscriber terminal 150 and transmits the received MBS channel connection request message to the second analyzing unit 241, and the second analyzing unit 241 analyzes the MBS channel connection request message received from the second transmitting/receiving unit 235. Also, the second transmitting/receiving unit 235 extracts channel information such as an ID or CID of the user sending the MBS channel connection request message, the occurrence/nonoccurrence of an MBS-type service connection request, a program ID, and a multicast IP address of a broadcast channel. Also, the second analyzing unit 241 transmits the extracted channel information to the control unit 239.

Herein, the occurrence/nonoccurrence of an MBS-type service connection request may be determined by the content and type of the received MBS channel connection request message. If the received MBS channel connection request message is an IGMP join message, it may be determined to be an MBS-type service connection request. Also, if the received MBS channel connection request message is an IGMP leave message, it may be determined to be an MBS-type service connection release request. Besides, an additional dedicated message may be used for the same purpose.

At step 333, the control unit 239 receives the channel information from the second analyzing unit 241 and searches an MCID table by using the received channel information. It is determined according to the search result whether identification information (e.g., a user ID or CID) of the user transmitting the MBS channel connection request message is registered. Herein, the MCID table records identification information of the user using an MCID, and a program ID and a multicast IP address that is information about a broadcast channel that is being serviced through the MCID.

If the identification information of the user transmitting the MBS channel connection request message has already been registered in the MCID table, the control unit 239 does not transmit a separate MCID value to the subscriber terminal 150. If the user is a first-accessed user of the MBS zone, the control unit 239 transmits a predetermined MCID value to the subscriber terminal 150 according to the video, audio and text attribute of MPEG2-TS data. Herein, if the same user requests a service connection for the MBS channel, the control unit 239 does not transmit the predetermined MCID value to the subscriber terminal 150.

At step 335, the control unit 239 transmits MCID/MBS burst allocation information to the combining unit 233 and transmits the MBS channel connection request message to the ASN 110. Thereafter, the ASN 110 transmits the MBS channel connection request message to the MBS server 170. At step 391, the MBS server 170 performs subscriber authentication and service authentication with respect to the MBS channel connection request of the subscriber terminal 150.

If the authentication is successful, the ASN 110 transmits a response message for the MBS channel connection request to the subscriber terminal 150 at step 393. Herein, the response message includes various information such as a decryption key, a program ID, and a user ID for use of the requested MBS channel. The frame receiving unit 251 of the subscriber terminal 150 receives a response message from the ASN 110 and transmits the received response message to the frame classifying unit 253.

The frame classifying unit 253 stores the MBS channel connection request response message in a unicast data buffer. The application program executing unit 261 executes the MBS channel connection request response message stored in the unicast data buffer through a related program. The application program executing unit 261 performs pre-processes for processing received MBS channel data by using the information (e.g., a user ID, a program ID, and a decryption key) included in the MBS channel connection request response message.

At step 395, the MBS server 170 transmits an MBS channel service initiation notification message to the ASN 110. When receiving the MBS channel service initiation notification message from the MBS server 170, the ASN 110 transmits an MBS burst region reservation request message to the base station 130.

At step 371, the control unit 239 of the base station 130 receives the MBS burst region reservation request message from the ASN 11. At step 337, the control unit 239 reserves a burst region corresponding to each MCID recorded in the MCID table. Thereafter, at step 339, the control unit 239 transmits a response message for the MBS burst region reservation request to the ASN 110. At step 341, the base station 130 performs path establishment for MBS channel data transmission between the MBS server 170 and the ASN 110 and between the base station 130 and the ASN 110 according to a predetermined method.

After normal completion of the MBS burst region reservation and the MBS channel data path establishment, the base station 130 determines at step 343 whether the connection for the MBS channel requested by the MBS channel selection signal is the first connection request. If it is determined that the connection for the MBS channel is the first connection request and the authentication to the subscriber and MBS service is successful, the base station 130 transmits an MCID allocation notification message to the subscriber terminal 150 at step 345. Herein, the MCID allocation notification message for each MBS channel data attribute includes an MCID value according to the video, audio and text attribute of the MBS channel data.

The frame receiving unit 251 of the subscriber terminal 150 receives the MCID allocation notification message for each MBS channel data attribute from the base station 130 and transmits the same to the frame classifying unit 253. The frame classifying unit 253 extracts/records MCID values included in the MCID allocation notification message. Thereafter, at step 315, the frame receiving unit 251 of the subscriber terminal 150 generates a response message for the MCID allocation notification message and transmits the generated response message to the base station 130.

If the connection for the MBS channel requested by the MBS channel selection signal is the first connection request, the base station 130 does not perform the step 345 and updates the attribute information (e.g., user identification information, a program ID, and a multicast IP address) in the MCID table at step 347.

Herein, a process of transmitting the MCID allocation notification message and the MCID allocation notification response message between the subscriber terminal 150 and the base station 130 conforms to a Dynamic Service Addition (DSA) process defined in the 802.16-based broadband wireless access system. The DSA process includes transmitting a DSA request message (DSA-REQ) from the base station 130 to the subscriber terminal 150, transmitting a DSA response message (DSA-RSP) from the subscriber terminal 150 to the base station 130, and transmitting a DSA acknowledgement message (DSA-ACK) for the DSA response message from the base station 130 to the subscriber terminal 150.

After completion of the path establishment, at step 397, the MBS server 170 converts the MPEG2-TS data, requested through the subscriber terminal 150, into IP-packetized data and transmits the IP-packetized data through the ASN 110 to the first transmitting/receiving unit 231 of the base station 130. The first transmitting/receiving unit 231 extracts header information of the IP-packetized MPEG2-TS data.

The first transmitting/receiving unit 231 transmits the extracted header information to the first analyzing unit 237. The first analyzing unit 237 analyzes the extracted header information to extract a destination IP address or an IP address of the received packet. Also, at step 349, the first analyzing unit 237 uses the destination IP address or the IP address to divide the data into MBS-type data and unicast-type data.

In particular, if the multicast IP address of the MBS channel is included in the extracted IP address, it is determined that the received packet includes MBS-type service data. Thus, in this case, the first analyzing unit 237 divides the attribute of the received packet into video, audio or text by using a multimedia attribute, and transmits the analyzed information to the combining unit 233.

At step 351, the combining unit 233 constructs an MBS burst region including an MCID corresponding to the attribute of an input packet by using the packet attribute information received from the first analyzing unit 237 and the MCID/MBS burst allocation information received from the control unit 239. Thereafter, the combining unit 233 combines the MBS burst region and unicast-type service data regions to construct a complete frame. Also, the combining unit 233 transmits the constructed frame to the second transmitting/receiving unit 235.

At step 353, the second transmitting/receiving unit 235 outputs a signal, which is obtained by modulating frame data including the MBS burst region in accordance with the standard of a physical layer, to a wireless section. The frame receiving unit 251 of the subscriber terminal 150 receives a frame from the second transmitting/receiving unit 235 of the base station 130 and transmits the received frame to the frame classifying unit 253. At step 317, if the frame has an MBS burst region corresponding to a predetermined MCID, the frame classifying unit 253 classifies the frame into data of the MBS burst region corresponding to the predetermined MCID prior to extraction.

At step 319, the frame classifying unit 253 records the extracted data in a buffer space of a predetermined size in the frame buffer 255 for each of video data, audio data and text data according to the buffer allocation policy. The application program executing unit 261 uses a video player or an audio player to receive data that are classified into video data, audio data and text data and are stored in the respective buffer regions.

Thereafter, at step 321, the application program executing unit 261 may provide a service of an MBS channel by identifying the MBS channel requested by the subscriber through multicast IP address information included in the IP header of a packet.

As described above, the present invention can allocate a multicast connection identifier to a user in a wireless access system by using a Multicast and Broadcast Service (MBS) mode. Also, the present invention allocates a multicast connection identifier (MCID) according to the type of data at an MBS service request and fixes the allocated MCID at the same value throughout the entire broadcast zone, thereby making it possible to prevent a service interruption, which may be caused by a handover of a subscriber terminal between base stations, and to reduce a broadcast channel switching time.

While the present invention has been described with respect to the specific embodiments, it will be apparent to those skilled in the art that various changes and modifications may be made without departing from the spirit and scope of the invention as defined in the following claims.

What is claimed is:

1. A base station for allocating a Multicast Connection IDentifier (MCID) in a wireless access system, comprising:
a first transmitting/receiving unit configured to exchange data with a content distribution network where a broadcast service providing server is located and to extract header information of the data;
a combining unit configured to construct the data on a frame basis in accordance with the data transmission standard of a wireless section;
a second transmitting/receiving unit configured to exchange the frame with a subscriber terminal receiving the constructed frame and to receive a Multicast and Broadcast Service (MBS) channel connection request message from the wireless section;
a first analyzing unit configured to extract attribute information of the data by analyzing the extracted header information and to analyze the type of the data by using the extracted attribute information;
a second analyzing unit configured to extract channel information by analyzing the MBS channel connection request message; and
a control unit configured to exchange an MBS burst reservation message with the content distribution network, to reserve/allocate an MBS burst region by using the MBS burst reservation message and the channel information, to allocate an MCID to the data, and to manage the registration state of an MBS channel corresponding to the MCID.

2. The base station of claim 1, wherein if the data are MBS data, the first analyzing unit uses multimedia information to classify the data as video data, audio data or text data.

3. The base station of claim 1, wherein the control unit comprises an MCID table configured to store a multicast IP address of the requested broadcast channel, a user ID or Connection Identifier (CID), and an MCID allocated according to the attribute of MBS data.

4. The base station of claim 1, wherein if the access of a user of the subscriber terminal is the first access, the control unit reserves a burst region corresponding to each MCID recorded in the MCID table.

5. The base station of claim 1, wherein if the access of a user of the subscriber terminal is not the first access, the control unit updates the attribute information in the MCID table.

6. The base station of claim 1, wherein the combining unit constructs an MBS burst region corresponding to the data by using the attribute information and the MBS burst region allocation information, and constructs a frame by combining the constructed MBS burst region and a unicast region.

7. The base station of claim 1, wherein the attribute information comprises a destination IP address and an IP address of the data.

8. The base station of claim 1, wherein the channel information comprises an user ID or CID of the user sending the MBS channel connection request message, the occurrence/nonoccurrence of an MBS-type service connection request, a program ID, and a multicast IP address of a broadcast channel.

9. The base station of claim 1, wherein the allocation notification message comprises an MCID value according to the video, audio and text attribute of MBS channel data.

10. The base station of claim 1, wherein the MCID is a value predetermined according to the attribute of data constituting a broadcast channel requested by the subscriber.

11. The base station of claim 10, wherein the MCID is determined to be the predetermined value through the entire broadcast zone.

12. The base station of claim 1, wherein the type of data comprises vide data, audio data, and text data.

13. A subscriber terminal for allocating a Multicast Connection IDentifier (MCID) in a wireless access system, comprising:
an application program executing unit configured to request or terminate a service according to the control of a subscriber and to provide the service execution result to the subscriber;
a request analyzing unit configured to classify the requested service as a Multicast and Broadcast Service (MBS) service or a unicast service, to determine whether the service request is the first request, and to generate/transmit a buffer allocation policy according to the determination result;
a buffer control unit configured to allocate or release a buffer in accordance with the buffer allocation policy and to manage the allocated buffer space;
a frame transmitting unit configured to construct a frame for information transmission and to transmit the constructed frame to a wireless section according to the transmission characteristics of a physical layer;
a frame receiving unit configured to receive a packet, transmitted through a wireless access network, through a physical layer and to decode a received signal;
a frame analyzing unit configured to classify information included in the received frame on a packet basis by using a wireless section connection identifier included in the decoded frame and to transmit the classified information to a predetermined buffer space; and
a frame buffer configured to store data classified on a packet basis according to the type of data.

14. The subscriber terminal of claim 13, wherein the subscriber receives an MCID allocated according to the attribute of data when requesting an MBS service.

15. The subscriber terminal of claim 13, wherein the type of the data comprises video data, audio data, and text data.

16. The subscriber terminal of claim 13, wherein the buffer allocation policy is used to allocate an independent buffer according to the type of the data.

17. A method for allocating a Multicast Connection IDentifier (MCID) in a wireless access system, comprising:
selecting a Multicast and Broadcast Service (MBS) channel and performing a buffer allocation policy;
allocating a buffer space of a predetermined size to each data type in accordance with the buffer allocation policy;
allocating an MCID value to the data according to a connection request for the MBS channel;
receiving a frame with an MBS burst region corresponding to the MCID and classifying/extracting data of the MBS burst region corresponding to the MCID;
storing the extracted data in a buffer region corresponding to the MCID of the extracted data; and
providing a service by identifying the MBS channel by using multicast IP address information included in an IP header of the data stored in the buffer region.

18. The method of claim 17, wherein the buffer allocation policy is used to allocate an independent buffer according to the type of the data.

19. The method of claim 18, wherein the MCID is a value predetermined according to the attribute of data constituting a broadcast channel requested by the subscriber.

20. The method of claim 18, wherein the MCID is determined to be the predetermined value through the entire broadcast zone.
